(19) United States
(12) Patent Application Publication
(10) Pub. No.: US 2026/0333363 A1
(43) Pub. Date: Oct. 22, 2026

(54) SOUNDING REFERENCE SIGNAL CONFIGURATION FOR THREE-PORT UPLINK TRANSMISSION

(71) Applicant: ZTE Corporation, Shenzhen (CN)

(72) Inventors: Ke YAO, Shenzhen (CN); Bo GAO, Shenzhen (CN); Yang ZHANG, Shenzhen (CN); Guangyu JIANG, Shenzhen (CN)

(21) Appl. No.: 19/702,979

(22) Filed: Jun. 9, 2026

Related U.S. Application Data
(63) Continuation of application No. PCT/CN2023/139307, filed on Dec. 15, 2023.

(51) Int. Cl. H04W 72/21; H04L 5/00

(52) U.S. Cl. CPC H04W 72/21; H04L 5/0051

(57) ABSTRACT

Some embodiments of the present disclosure are related to configurations of sounding reference signal (SRS) to support three-port uplink transmission. An example wireless communication method includes: receiving, by a user equipment (UE) from a base station (BS), a sounding reference signal (SRS) configuration; receiving, by the UE from the BS, an SRI information for a PUSCH transmission; and transmitting, by the UE to the BS, the PUSCH transmission according to antenna ports of one or more SRS resources indicated by the SRI information.

### CROSS-REFERENCE TO RELATED APPLICATION(S)

This application is a continuation of International Patent Application No. PCT/CN2023/139307, filed on Dec. 15, 2023. The entire contents of the before-mentioned patent application is incorporated by reference as part of the disclosure of this application.

### TECHNICAL FIELD

This disclosure is directed generally to digital wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs. Various techniques, including new ways to provide higher quality of service, longer battery life, and improved performance are being discussed.

### SUMMARY

Techniques are disclosed for configuring SRS transmission to support three-port uplink transmission. Herein, “support” may mean, for example, to perform a PUSCH transmission using exactly the same ports used in this SRS transmission, or a sub-group of the ports used in the SRS transmission. Herein, a Tx may correspond to a port; a Tx or port is used interchangeable with a Tx port, an antenna port, a transmit antenna, or a transmit antenna port.

In one aspect, a method of wireless communication performed by a wireless device (e.g., a user equipment (UE)) is disclosed. The method includes: receiving, by a UE from a network device (e.g., a base station (BS)), a sounding reference signal (SRS) configuration; receiving, by the UE from the BS, an SRI information for a PUSCH transmission; and transmitting, by the UE to the BS, the PUSCH transmission according to antenna ports of one or more SRS resources indicated by the SRI information.

In another aspect, a method of wireless communication performed by a network device is disclosed. The method includes: transmitting, by a base station (BS) to a user equipment (UE), a sounding reference signal (SRS) configuration; transmitting, by the BS to the UE, an SRI information for a PUSCH transmission; and receiving, by the BS from the UE, the PUSCH transmission.

In yet another exemplary aspect, the above-described methods are embodied in the form of processor-executable code and stored in one or more non-transitory computer-readable storage media. The code included in the computer readable storage media when executed by one or more processors, causes the one or more processors to implement the methods described in this patent document.

In yet another exemplary embodiment, a wireless communication device that is configured or operable to perform the above-described methods is disclosed. The wireless communication device may be a wireless device (e.g., a user equipment (UE)), or a network device (e.g., a base station (BS)).

The above and other aspects and their implementations are described in greater detail in the drawings, the descriptions, and the claims.

### BRIEF DESCRIPTION OF THE DRAWING

FIG. 1 shows an example of a wireless communication system in accordance with some embodiments of the disclosed technology.

FIG. 2 is a block diagram representation of a portion of an apparatus in accordance with some embodiments of the disclosed technology.

FIG. 3 illustrates an example in which one three-port SRS resource is transmitted based on a three-port SRS pattern to support a three-port PUSCH transmission in accordance with some embodiments of the disclosed technology.

FIGS. 4 and 5 illustrate examples in which an SRS resource is transmitted based on a four-port SRS pattern to support a three-port PUSCH in accordance with some embodiments of the disclosed technology.

FIG. 6 illustrates an example in which a three-port SRS transmission is implemented by combining two SRS resources to support a three-port PUSCH transmission in accordance with some embodiments of the disclosed technology.

FIG. 7 is a flowchart of an example method of wireless communication.

FIG. 8 is a flowchart of an example method of wireless communication.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

The new radio (NR) technology of fifth generation (5G) mobile communication systems is continuously improved to provide higher quality wireless communication. Multiple Input Multiple Output (MIMO) is one of key features in 5G NR. Legacy technique for MIMO has already supported 2, 4, and 8 transmit (Tx) ports for UL transmission.

Generally, if more than one transmit antenna (1Tx) is equipped for a user equipment (UE), 2 Tx, 4Tx or 8Tx UE is considered, so codebook for physical uplink shared channel (PUSCH) is specified as 2 ports, 4 ports, or 8 ports for such requirements. However, in reality, a UE is commonly equipped with 1Tx or 2Tx, and 4Tx UE is rare due to cost and/or complexity. As a compromise, 3Tx is considered for UE configuration as a next step of 2Tx UE. To support 3Tx UE, 3Tx UL transmission schemes need be designed, e.g., 3Tx (port) PUSCH transmission, and/or 3Tx (port) sounding reference signals (SRS).

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include downlink control information (DCI) or high layer signaling or downlink information. The UE may be, for example, a smartphone, a tablet, a mobile computer, a machine to machine (M2M) device, a terminal, a mobile device, an Internet of Things (IoT) device, and so on.

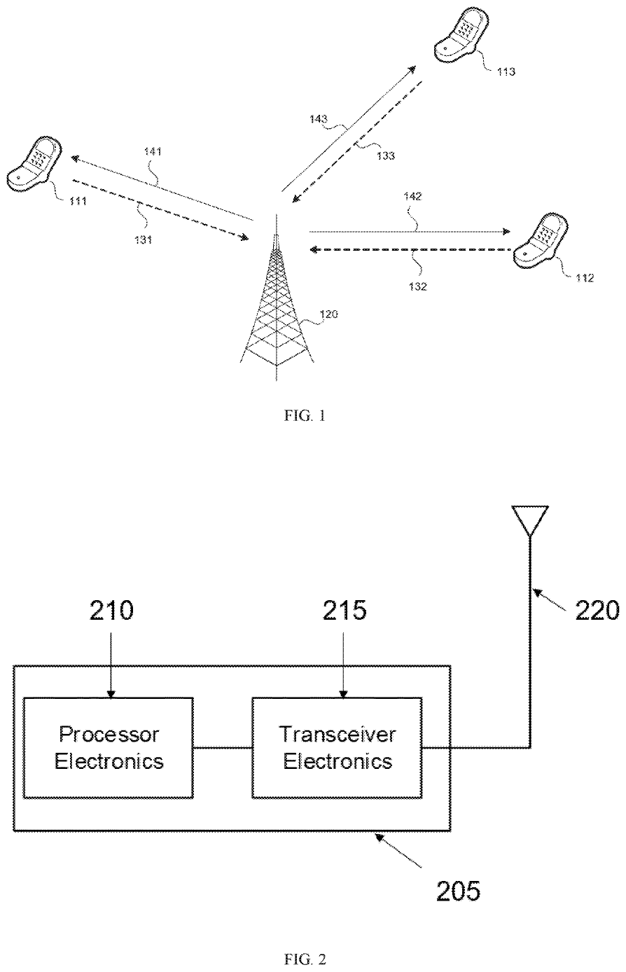

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

SRS in wireless communication is used in multiple aspects for efficient network performance, especially in LTE (Long-Term Evolution) and 5G networks. Channel sounding may involve sending a known signal from a transmitter (e.g., a UE), which is then analyzed at the receiver (e.g., a BS) to gain information about the wireless channel. This process may help in understanding various characteristics of the communication channel, such as path loss, fading, delay spread, Doppler spread, etc. SRS may enable the network to adaptively optimize data transmission for efficiency, speed, and reliability.

Merely by way of example, to perform an uplink transmission, a user equipment (UE) transmits SRS to a base station. Upon receiving the SRS, the base station may perform channel estimation. This process involves analyzing the SRS to understand the channel conditions, such as path loss, fading, and interference patterns. The channel estimation may give the base station a detailed understanding of how a signal propagates from the UE to the base station over the uplink channel. Based on the channel estimation, the base station may determine information including, e.g., ports to be used for a subsequent uplink transmission (e.g., a PUSCH transmission), a precoding matrix, etc. The ports to be used, including the number (or count) of the ports, may be specified in SRS resource indicator (SRI) information. This matrix may be designed to optimize the transmission for the specific channel conditions encountered by the SRS. The precoding matrix may adjust the amplitude and phase of an uplink signal before transmission, thereby improving signal reception under given channel conditions. The precoding matrix (or the parameters/instructions based on it) may be then conveyed back to the UE. This feedback can be explicit, where the exact precoding matrix is sent back, or implicit, where the UE is instructed on how to adjust its transmission parameters based on the matrix. The UE may apply this precoding matrix to the data signal and transmitting it via the ports indicated by the SRI information on the channel. Accordingly, the channel sounding by SRS may allow effective adjustment of the uplink signal to counteract the impairments and distortions identified in the uplink channel, thereby enhancing the effectiveness of the signal transmission. This process is dynamic and adaptive. As the channel conditions change, due to factors like UE mobility or varying interference, the base station may update the precoding matrix based on new SRS measurements and feeds this information back to the UE.

To support a three-port uplink transmission (e.g., PUSCH transmission), three-port SRS is needed. In some embodiments, the UE receives, from the BS, an SRS configuration, determines a transmit resource of SRS, and transmit the SRS accordingly. The transmit resource may include, e.g., a time domain resource, a frequency domain resource, a code domain resource, an orthogonal frequency-division multiplexing (OFDM) symbol index, a slot index, a comb offset, a cyclic shift, or the like, or a combination thereof. SRS to support three-port uplink transmission can be realized by one of the following schemes: one SRS resource configured with three ports, more than one SRS resource being combined to provide three ports, or one SRS resource configured with more than three ports (e.g., four ports), with one or more port not used for three-port uplink transmission. BS, based on the received SRS, may determine SRS resource indicator (SRI) and/or transmit precoding matrix indicator (TPMI) for a subsequent three-port uplink transmission. Details are provided as follows.

### Embodiment 1: SRS Resource(s) to Support Three-Port PUSCH Transmission

To support three-port PUSCH transmission, at least three-port SRS is needed. SRS may be transmitted by a UE to a network using three different ports, the network estimates the SRS, and then determines a three-port codebook (precoder) for PUSCH transmission.

Case 1: One SRS Resource with Three Ports

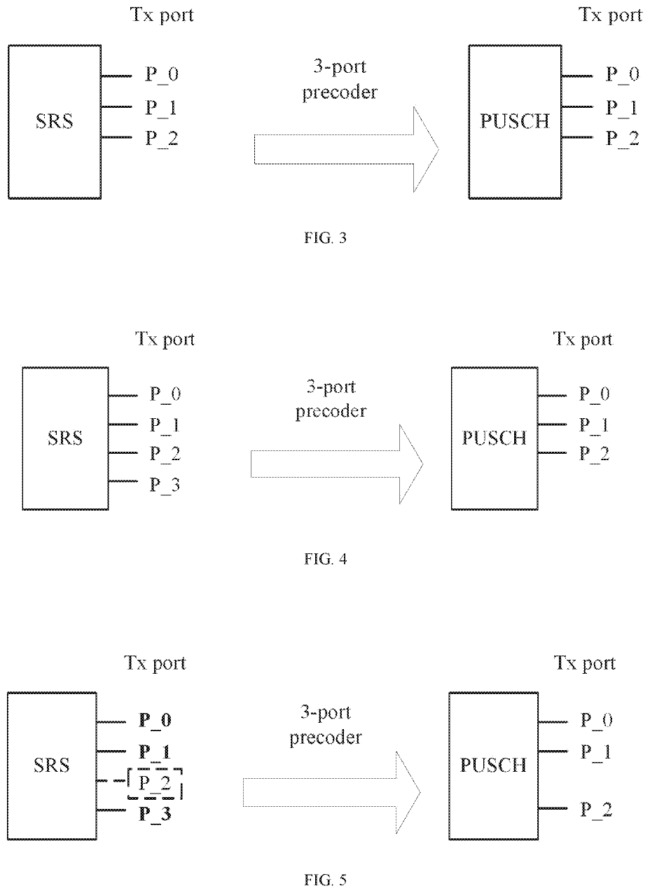

A network device (e.g., a BS) may transmit to a wireless device (e.g., a UE) an SRS configuration. The UE may configure a transmit resource of SRS (or referred to as an SRS resource) with three ports for the SRS transmission. The subsequent PUSCH transmission may be via the same three ports used in the three-port SRS transmission. As illustrated in FIG. 3, an SRS resource is configured to be transmitted via three ports P_0, P_1, and P_2 from the UE to the network device. The network device generates a three-port precoder based on the three-port SRS, and the UE performs an uplink transmission (e.g., a PUSCH transmission) via the three ports P_0, P_1, and P_2 by referring to the three-port precoder.

A transmit resource for SRS with 3 ports can be a 3-port SRS pattern. A transmit resource for SRS may include at least frequency domain resource (e.g., RB (resource block), comb offset), time domain resource (e.g., frame index, subframe index, slot index, OFDM symbol index), or code domain resource (e.g., cyclic shift, i.e., CS). For more than one port SRS transmission, different ports correspond to different time domain parameters (e.g., symbol), different frequency domain parameters (e.g., comb offset), and/or different code domain parameters (e.g., CS), in order to keep orthogonality among the ports.

A 3-port SRS pattern may mean that at least one time domain parameter, one frequency domain parameter, and/or one code domain parameter is configured for the SRS resource. A transmit resource for one port can be determined by such configured time domain, frequency domain, or code domain parameters, e.g., for the first port, and transmit resources for the other two ports can be determined by such configured parameters by adding an offset value considering 3 ports in total. For example, comb length-4, comb offset 0 and CS 0 are configured for an SRS resource, port 0 is determined by comb offset 0, CS 0 by default, and port 1, port 2 can be determined as same comb offset as port 0, different CS from port 0, alternatively, port 1, port 2 can be determined as different comb offset from port 0, same CS as port 0.

An offset value considering 3 ports in total refers to allocating different comb offsets for different 3 ports with evenly or near-evenly splitting gaps, or allocating different CSes for different 3 ports with evenly or near-evenly splitting gaps. For example, a total of 12 CSes can be allocated to 3 ports with an evenly splitting gap of 12/3=4; accordingly, if port 0 is determined as CS index 0, port 1 and 2 are determined as CS index 4 and 8, respectively. Three ports can share a same comb offset, or different 3 comb offsets. Alternatively, 3 ports can have partially different comb offsets, e.g., 2 port having a same comb offset, and 1 port having another comb offset.

Case 2: One SRS Resource with More than Three Ports

In some embodiments, a network device (e.g., a BS) may transmit to a wireless device (e.g., a UE) an SRS configuration. The UE may configure, for an SRS transmission, one SRS resource with more than three ports, e.g., four ports. In this case, a transmit resource for one port can be determined by configuring time domain, frequency domain, or code domain parameters, e.g., for the first port, and the transmit resources for other two ports can be determined based on such configured parameters by adding an offset value considering 4 ports in total.

An offset value considering 4 ports in total refers to allocating different comb offsets for different 4 ports with evenly or near-evenly splitting gaps, or allocating different CS for different 4 ports with evenly or near-evenly splitting gaps. For example, a total of 12 CSs can be allocated to 4 ports with an evenly splitting gap of 12/4=3; then if port 0 is determined as CS index 0, port 1, 2 and 3 are determined as CS index 3, 6, and 9, respectively. Four ports can share a same comb offset, or different 4 comb offsets. Or 4 ports can have partially different comb offsets, e.g., 2 port sharing a same comb offset, and the other 2 ports sharing another comb offset. That means a total of 2 different comb offsets are allocated to 4 ports.

A subsequent three-port PUSCH transmission may be determined based on the four-port SRS transmission and selection information. In some embodiments, the selection information may be predefined, or indicated by a DCI signaling, or an RRC signaling. In some embodiments, the selection information may indicate that 1 port among the 4 ports of the 4-port SRS pattern is excluded from the subsequent three-port PUSCH transmission, or that 3 ports of the 4 ports of 4-port SRS pattern are used in the three-port PUSCH transmission.

To determine 3 ports among 4 ports, a port selection information can be used. The port selection information can be a 4-bit bitmap, and each bit corresponding to the corresponding port is selected or not selected (excluded). E.g., “0001” means the fourth port is not selected, which means the first 3 ports are selected. “1101” means the first, second and the fourth ports are selected.

The port selection information can be a 2-bit information, and each value of 2-bit corresponding to a respective port which is not selected (excluded). E.g., “00” means the first port is not selected, which means the second, third and fourth ports are selected.

The port selection information can be indicated to the UE via an RRC signaling, medium access control (MAC) control element (CE), or DCI signaling. The port selection information may not explicitly exist, but 3 ports among 4 ports can also be predefined, e.g., the first or the last 3 ports are selected, or the last or the first port is not selected.

As illustrated in FIG. 4, an SRS resource sequence and/or SRS resource mapping is determined based on four ports P_0, P_1, P_2, and P_3, via which a four-port SRS is transmitted from the UE to the network device. The network device generates a three-port precoder based on the four-port SRS, and the UE performs an uplink transmission (e.g., a PUSCH transmission) via three of the four ports P_0, P_1, P_2, and P_3 by referring to the three-port precoder. One port used in the four-port SRS transmission is not used in the three-port PUSCH transmission. By the four-port SRS transmission, the network device can learn the channel condition associated with the four ports, and may select three ports for the three-port PUSCH transmission based on the detected channel condition so as to improve or optimize the PUSCH transmission accordingly.

As FIG. 4 illustrates, among P_0, P_1, P_2, and P_3 used in the four-port SRS transmission, P_0, P_1, and P_2 are used in the PUSCH transmission, and P_3 used in the four-port SRS transmission is not used in the three-port PUSCH transmission. It is understood that FIG. 4 is provided for illustration purposes, and not intended to be limiting. The specific port that is used in a four-port SRS transmission but not in the three-port PUSCH transmission may be selected based on the selection information relating to one or more factors including, e.g., a condition of the UE (e.g., a capability condition of the UE), a channel condition encountered by the SRS, etc., and may be adjusted in response to a change in the channel condition as the network device detects via a next SRS transmission. Merely by way of example, in some embodiments, among P_0, P_1, P_2, and P_3 used in the four-port SRS transmission, P_0, P_2, and P_3 may be used in the PUSCH transmission, and P_1 used in the four-port SRS transmission is not used in the three-port PUSCH transmission. As another example, among P_0, P_1, P_2, and P_3 used in the four-port SRS transmission, P_0, P_1, and P_2 are used in a PUSCH transmission, and P_3 used in the four-port SRS transmission is not used in the three-port PUSCH transmission; in response to a change in the channel condition encountered by a next four-port SRS transmission via the same four ports, P_0, P_2, and P_3 is used in a next PUSCH transmission, and P_1 used in the four-port SRS transmission is not used in the next three-port PUSCH transmission.

In some embodiments, a network device (e.g., a BS) may transmit to a wireless device (e.g., a UE) an SRS configuration. The UE may configure, for a three-port SRS transmission, one three-port SRS resource by determining an SRS resource sequence and/or SRS resource mapping based on the four-port SRS pattern and selection information. In some embodiments, the selection information may be predefined, or indicated by a DCI signaling, or an RRC signaling. In some embodiments, the selection information may indicate that 1 port among the 4 ports of the 4-port SRS pattern is excluded from the three-port SRS transmission, or that 3 ports of the 4 ports of 4-port SRS pattern are used in the three-port SRS transmission. The subsequent PUSCH transmission may be via the same three ports used in the three-port SRS transmission. As illustrated in FIG. 5, a three-port SRS resource sequence and/or SRS resource mapping is determined based on four ports P_0, P_1, P_2, and P_3 such that a three-port SRS is transmitted via P_0, P_1, and P_3 from the UE to the network device. The network device generates a three-port precoder based on the three-port SRS, and the UE performs a PUSCH transmission via the three ports P_0, P_1, and P_3 by referring to the three-port precoder. Port P_2 is available but not used in the three-port SRS transmission and not used in the three-port PUSCH transmission. Unlike the example embodiments as illustrated in FIG. 4, according to the embodiments as illustrated in FIG. 5, by omitting a port from the four ports potentially available for an SRS transmission, the network device does not learn the channel condition associated with the omitted port; however, the SRS transmission may proceed based on three out of four ports that are potentially available, thereby reducing the hardware usage associated with the SRS transmission.

As FIG. 5 illustrates, among P_0, P_1, P_2, and P_3 potentially available for a three-port SRS transmission, P_0, P_1, and P_3 are used in the three-port SRS transmission and the corresponding three-port PUSCH transmission, and P_2 is not used in the three-port SRS transmission or the corresponding three-port PUSCH transmission. It is understood that FIG. 5 is provided for illustration purposes, and not intended to be limiting. The specific port that is not used in a three-port SRS transmission or a corresponding three-port PUSCH transmission may be selected based on the selection information relating to one or more factors including, e.g., a condition of the UE (e.g., the capability of the UE at or around the time of an SRS transmission and/or a PUSCH transmission), a channel condition encountered by the SRS, and may be adjusted in response to a change in the channel condition as the network device detects via a next SRS transmission. Merely by way of example, in some embodiments, among P_0, P_1, P_2, and P_3 potentially available for a three-port SRS transmission and/or a three-port PUSCH transmission, P_0, P_1, and P_2 may be used in both, and P_3 is not used in either one of the three-port SRS transmission or the three-port PUSCH transmission. As another example, among P_0, P_1, P_2, and P_3 potentially available for a three-port SRS transmission and/or a three-port PUSCH transmission, P_0, P_1, and P_3 are used in a PUSCH transmission, and P_2 is omitted; in response to a change in the UE condition, P_0, P_2, and P_3 is used in a next three-port SRS transmission and a corresponding three-port PUSCH transmission, and P_1 is not used in either one of next three-port SRS transmission or the next three-port PUSCH transmission.

Case 3: More than One SRS Resource to Support Three-Port SRS

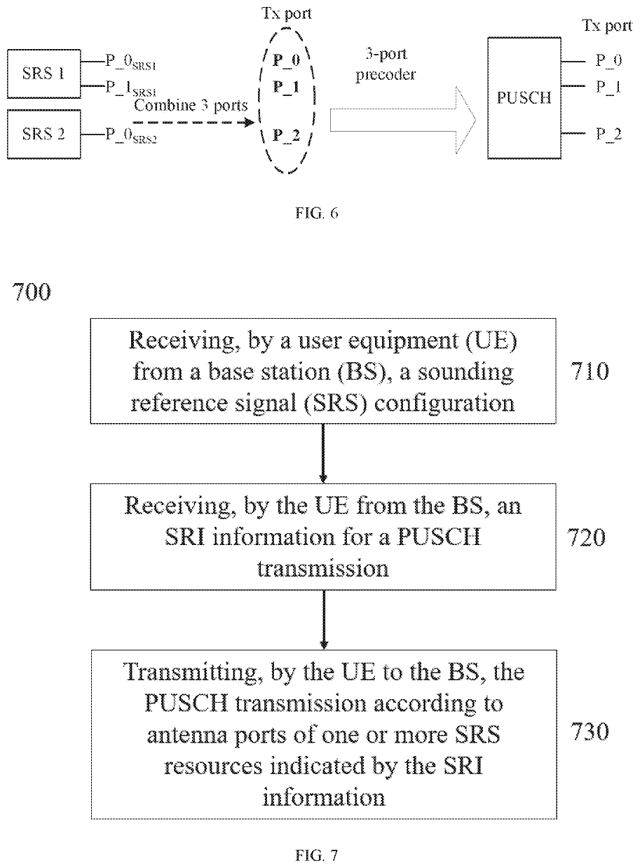

A UE can be configured with more than one SRS resource to support three-port SRS. For example, a UE can be configured with one two-port SRS resource and one one-port SRS resource to support three-port SRS, as shown in FIG. 6. The two SRS resources can be in one SRS resource set, or in two SRS resource sets.

As FIG. 6 illustrates, an SRS resource SRS 1 is configured with two ports, P_0_{SRS1} and P_1_{SRS1} of SRS1, and an SRS resource SRS2 is configured with one port, P_0_{SRS2} of SRS2. SRS1 and SRS2 are combined to support a three-port SRS transmission via SRS ports P_0, P_1, and P_2 from the UE to the network device. The network device generates a three-port precoder based on the three-port SRS transmission, and the UE performs a three-port PUSCH transmission via the three ports P_0, P_1, and P_2 by referring to the three-port precoder.

To combine the more than one SRS resource to support a three-port PUSCH transmission, and some restrictions for configuration or triggering scheme may be needed.

Regarding the time domain resource of the transmit resource, the more than one SRS resource that collectively support the three-port SRS transmission can be transmitted in same symbol(s), or in continuous symbols. Otherwise, the transmission of symbols corresponding to the more than one SRS resource may be within a time interval, or start from a same symbol. As used herein, same symbols mean that each symbol carries all 3 ports SRS transmission; that is, each symbol contains SRS information from all three antenna ports. More than one symbol may be used for SRS repetition. As used herein, continuous symbols mean that each symbol may carry one or two ports SRS transmission, but all 3 ports SRS transmission are completed in symbols arranged in a sequential and uninterrupted manner.

Regarding the frequency domain resource of the transmit resource, the more than one SRS resource that collectively support the three-port SRS transmission can be configured with one or more same parameters including, e.g., a same comb offset requirement, a same comb number, a same frequency hopping parameter, a same partial frequency hopping parameter, etc.

Regarding the code domain resource of the transmit resource, different ports in the more than one SRS resource that collectively support the three-port SRS transmission can correspond to different cyclic shifts (CSs) to differentiate SRS signals transmitted from the three antenna ports of the UE.

Regarding spatial domain resource of the transmit resource, the more than one SRS resource can be configured with (or be assumed as) the same spatial filter, or associated with the same QCL (quasi-co-location) type D reference signal (RS).

In some embodiments, SRS transmissions may be periodic, e.g., every few milliseconds. In some embodiments, SRS transmissions may be aperiodic and do not follow a fixed, regular interval; instead, they may be triggered by specific events or conditions in the network. If the more than one SRS resource that collectively support the three-port SRS transmission are configured in different SRS resource sets with an aperiodic time behavior, the SRS resource sets may be configured to be triggered at the same time.

Support of simultaneous transmission for two SRS resources may be subject to UE capability.

UE may assume that antenna ports from different SRS resources that collectively support the three-port SRS transmission correspond to different UE antenna ports. The different SRS resources may belong to a same SRS resource set or different SRS resource sets.

### Embodiment 2: SRI Related Aspect of SRS Transmission to Support Three-Port PUSCH Submission

The sounding reference signal resource indicator (SRI) may identify the configuration for an uplink transmission (e.g., a PUSCH transmission) by a UE. SRI is used to specify the ports relating to the SRS resource(s) the UE may use for the uplink transmission.

### Case 1: One SRS Resource Transmitted on Three Ports, and Case 2: One SRS Resource Transmitted on Three Ports or Four Ports Using Four-Port SRS Pattern

In some embodiments, an SRS transmission to support a three-port PUSCH transmission may be transmitted by the UE via three ports according to one SRS resource that is configured with three port. The same three ports may be used in the three-port PUSCH transmission. In some embodiments, an SRS transmission to support a three-port PUSCH transmission may be transmitted by the UE via three ports according to one SRS resource that is configured with more than three ports (e.g., a 4-port SRS pattern), and at least one of the more than three ports is excluded to determine three ports for the SRS transmission. The same three ports used in the three-port SRS transmission may be used in the three-port PUSCH transmission. In some embodiments, an SRS transmission to support a three-port PUSCH transmission may be transmitted by the UE according to one SRS resource that is configured with more than three ports (e.g., a 4-port SRS pattern), and at least one of the more than three ports is excluded to determine three ports for the PUSCH transmission. See, e.g., FIGS. 3-5. An SRS resource with three ports or four ports can be indicated by an SRI field in a radio resource control (RRC) signaling or in a DCI scheduling message sent by the BS to the UE. The SRI field can be replaced by SRS information.

Case 3: More than One SRS Resource to Support Three-Port SRS

In some embodiments, two SRS resources may be combined to support three-port SRS transmission. An SRS resource may be configured with two ports, and another SRS resource is configured with one port. The two SRS resources may be referred to as an SRS resource group or an SRS resource pair. The pair of SRS resources can be within one SRS resource set. The pair of SRS resources can be configured in different SRS resource sets, i.e., one SRS resource is in one SRS resource set, and another SRS resource is in another SRS resource.

In some embodiments, the pair of SRS resources in which an SRS resource is configured with two ports and an SRS resource is configured with one port may be indicated by a value of an SRI field. In other words, a pair of SRS resources can be indicated by an SRI field in an RRC signaling or DCI scheduling message. In some embodiments, the pair of SRS resources can also be indicated by two SRI fields in an RRC signaling or DCI scheduling message.

For example, a first SRS resource with one port and a second SRS resource with two ports may be combined to support a three-port SRS transmission (e.g., as illustrated in FIG. 6). The first SRS resource and the second SRS resource may belong to a same SRS resource set, or two different SRS resource sets. The first SRS resource and the second SRS resource may be indicated in one or two SRI fields in an RRC scheduling message sent by the BS to the UE.

When two SRI fields are used, the case of combining ports of two SRS resources for one PUSCH transmission may be differentiated from the case that two SRS resources corresponding to two PUSCH transmissions as follows. If at least one of the following conditions are met, two SRI fields are used to indicate combining ports of two SRS resources to support one PUSCH transmission: the UE is configured with 3 ports; the UE is indicated an information to combine ports of 2 SRI fields; or one SRI filed indicating an SRS resource with two ports and another SRI filed indicating an SRS resource with one port.

There may be different configuration cases as follows for SRS resource and SRS resource set:
(1) one SRS resource set including one two-port SRS resource and one one-port SRS resource. No SRI field is needed.
(2) one SRS resource set including more than one two-port SRS resource and more than one one-port SRS resource. An SRI field is needed to indicate a pair of SRS resources, in which one SRS resource is configured with two ports and another one SRS resource is configured with one port.
(3) Two SRS resource sets, one SRS resource set includes one two-port SRS resource and another one SRS resource set includes one one-port SRS resource. An SRI field may not be needed. If only two SRS resources are configured for a codebook or non codebook based transmission, an SRS resource set indicator may not be needed. If there are more than two SRS resource sets (e.g., three SRS resource sets each including one SRS resource that is configured with one port) configured for a codebook or non codebook based transmission, an SRS resource set indicator may be needed.
(4) Two SRS resource sets, one SRS resource set includes more than one two-port SRS resource and another one SRS resource set includes more than one one-port SRS resource. There may be two SRI fields, each SRI field indicating one SRS resource corresponding to one SRS resource set.

### Embodiment 3: TPMI Related Aspect of SRS Transmission to Support Three-Port PUSCH Submission

TPMI and the number (or count) of layers (relating to rank) can be jointly indicated in one DCI field.

### Case 1: One SRS Resource Transmitted on Three Ports, and Case 2: One SRS Resource Transmitted on Three Ports or Four Ports Using Four-Port SRS Pattern

In some embodiments, an SRS transmission to support a three-port PUSCH transmission may be transmitted via three ports according to one SRS resource that is configured with three port. The same three ports may be used in the three-port PUSCH transmission. In some embodiments, an SRS transmission to support a three-port PUSCH transmission may be transmitted by the UE via three ports according to one SRS resource that is configured with more than three ports, and at least one of the more than three ports is excluded to determine three ports for the SRS transmission. The same three ports used in the three-port SRS transmission may be used in the three-port PUSCH transmission. In some embodiments, an SRS transmission to support a three-port PUSCH transmission may be transmitted by the UE via more than three ports (e.g., four ports) according to one SRS resource that is configured with more than three ports (e.g., four ports), and at least one of the more than three ports is excluded to determine three ports for the PUSCH transmission. See, e.g., FIGS. 3-5. The number (or count) of ports for TPMI may be determined according to the number (or count) of ports for the one SRS resource corresponding to a PUSCH transmission. This scheme may be used for the case that only one SRS resource is determined for a PUSCH transmission in a scheduling.

Case 3: More than One SRS Resource to Support Three-Port SRS

In some embodiments, two SRS resources may be combined to support a three-port SRS transmission. An SRS resource may be configured with two ports, and an SRS resource configured with one port. The number (or count) of ports for TPMI may be determined according to a sum of the numbers (or count) of ports for each SRS resource corresponding to a PUSCH transmission. The SRS resources can be determined for a PUSCH transmission based on one or more SRI indication in one scheduling, or all SRS resources in one SRS resource set without SRI indication for one scheduling. This scheme may be used for the case that more than one SRS resource is determined for a PUSCH transmission in a scheduling. See, e.g., FIG. 6 in which two SRS resources are indicated for one PUSCH transmission. One SRS resource is configured with two ports, the other one SRS resource is configured with 1 port, and then two ports+one port=three ports is determined for the number (or count) of ports for TPMI.

### Embodiment 4: Mapping Between SRS Ports and PUSCH Ports

Mapping between SRS ports and PUSCH ports can be determined as follows:

For more than one SRS resource, first designating ports in one resource in an ascending order, and then designating SRS resource ID in an ascending order. For example, SRS resource 0 is configured with 2 ports, and SRS resource 1 is configured with 1 port, and SRI for a PUSCH transmission indicates SRS resource 0 and SRS resource 1, and then designating the PUSCH port numbering based on the order of the first port and the second port in SRS resource 0, and the only one port in SRS resource 1 corresponds to 3 ports of PUSCH, e.g., PUSCH port 0, 1, 2, respectively.

The SRS resources order for port mapping can be determined based on SRS resources order indicated by SRI. The SRI can be indicated by one field, a value may indicate 2 SRS resources, e.g., SRS resource 0 and SRS resource 1 means SRS resource 0 first and SRS resource 1 second, or SRS resource 1 and SRS resource 0 means SRS resource 1 first and SRS resource 0 second. SRS resource 0 or SRS resource 1 can be configured with one or two ports. The sum of the numbers (or counts) of ports of SRS resource 0 and SRS resource 1 is 3.

The mapping between SRS ports and PUSCH ports can be determined according to a mapping indication. The mapping indication can be indicated to a UE by a network via an RRC signaling, a MAC CE, or a DCI signaling.

The mapping indication can indicate the order of more than one SRS resource for the port mapping, in an ascending or descending order of the SRS resource ID (index), or in an ascending or descending order of the number (or count) of ports configured for SRS resources (e.g., ascending order: SRS resource with 1 port first, and SRS resource with 2 ports second).

The mapping indication can indicate the order of more than one SRS resource for port mapping, e.g., in an ascending or descending order of SRS resource ID (index).

The mapping indication can indicate a mapping relation between SRS ports and PUSCH port among more than one predefined mapping relations. For example, the predefined mapping relations can include 6 cases as shown in the table below. Mapping index 0 means SRS port 0, 1, 2 are mapping to PUSCH ports 0, 1, 2 respectively. Mapping index 5 means SRS port 0, 1, 2 are mapping to PUSCH ports 2, 1, 0 respectively.

| Mapping index | SRS ports | PUSCH ports |
|---|---|---|
| 0 | 0, 1, 2 | 0, 1, 2 |
| 1 | 0, 1, 2 | 1, 2, 0 |
| 2 | 0, 1, 2 | 1, 0, 2 |
| 3 | 0, 1, 2 | 0, 2, 1 |
| 4 | 0, 1, 2 | 2, 0, 1 |
| 5 | 0, 1, 2 | 2, 1, 0 |

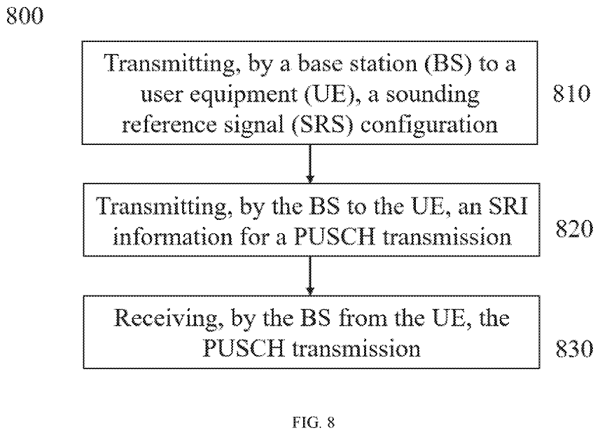

Some embodiments may implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station. The following listing of solutions may be implemented by some preferred embodiments.
1. A method (e.g., method 700 as shown in FIG. 7), including: receiving 710, by a user equipment (UE) from a base station (BS), a sounding reference signal (SRS) configuration; receiving 720, by the UE from the BS, an SRI information for a PUSCH transmission; and transmitting 730, by the UE to the BS, the PUSCH transmission according to antenna ports of one or more SRS resources indicated by the SRI information.
2. A method (e.g., method 800 as shown in FIG. 8), including: transmitting 810, by a base station (BS) to a user equipment (UE), a sounding reference signal (SRS) configuration; transmitting 820, by the BS to the UE, an SRI information for a PUSCH transmission; and receiving 830, by the BS from the UE, the PUSCH transmission.
3. The method of any one or more of the solutions disclosed herein, in which the SRI information is indicated by a DCI signaling or by an RRC signaling.
4. The method of any one or more of the solutions disclosed herein, in which: the SRI information indicates one SRS resource which is configured with 3 ports, an SRS transmission related to the one indicated SRS resource is transmitted by the UE using 3 ports, and a transmit resource for the SRS transmission is determined based on a 4-port SRS pattern and a selection information.
5. The method of any one or more of the solutions disclosed herein, in which: the SRI information indicates one SRS resource which is configured with 4 ports; in response to 3 transmit antenna ports being determined by the UE; an SRS transmission related to the one indicated SRS resource is transmitted by the UE using 3 ports, and a transmit resource for the SRS transmission is determined based on a 4-port SRS pattern and a selection information.
6. The method of any one or more of the solutions disclosed herein, in which the PUSCH transmission is transmitted using same three ports as the one SRS resource indicated by the SRI information.
7. The method of any one or more of the solutions disclosed herein, in which the transmit resource for the SRS transmission includes at least one of a time domain resource, a frequency domain resource, a code domain resource, an orthogonal frequency-division multiplexing (OFDM) symbol index, a slot index, a comb offset, or a cyclic shift.
8. The method of any one or more of the solutions disclosed herein, in which: the SRI information indicates one SRS resource which is configured with 4 ports; and an SRS transmission related to the one indicated SRS resource is transmitted by the UE using 4 ports.
9. The method of any one or more of the solutions disclosed herein, in which the PUSCH transmission is transmitted using 3 ports among the 4 ports of the one SRS resource indicated by the SRI information based on a selection information, in response to 3 transmit antenna ports being determined by the UE.
10. The method of any one or more of the solutions disclosed herein, in which: the selection information is predefined, or indicated by a DCI signaling, or an RRC signaling; or the selection information indicates that 1 port among the 4 ports of the 4-port SRS pattern is excluded from the PUSCH transmission or SRS transmission, or that 3 ports of the 4 ports of 4-port SRS pattern are involved in the PUSCH transmission or SRS transmission.
11. The method of any one or more of the solutions disclosed herein, further including: the SRI information indicates one SRS resource which is configured with 3 ports; and at least one of: an SRS transmission related to the one indicated SRS resource is transmitted by the UE using 3 ports; or the PUSCH transmission is transmitted using same 3 ports as the one SRS resource indicated by the SRI information. The SRS transmission and the PUSCH transmission can be determined independently.
12. The method of any one or more of the solutions disclosed herein, in which: the SRI information indicates more than one SRS resource which is configured with a sum of 3 ports; and at least one of: an SRS transmission is transmitted by the UE using the sum of 3 ports of the more than one SRS resource; or the PUSCH transmission is transmitted using same 3 ports of the more than one SRS resource indicated by the SRI information.
13. The method of any one or more of the solutions disclosed herein, in which the SRI information is indicated by one SRI field, or more than one SRI field.
14. The method of any one or more of the solutions disclosed herein, in which the more than one SRS resource includes two SRS resources, one in the two SRS resources is configured with one port, and the other one in the two SRS resources is configured with two ports.
15. The method of any one or more of the solutions disclosed herein, in which the more than one SRS resource includes three SRS resources, and each one of the three SRS resources is configured with one port.
16. The method of any one or more of the solutions disclosed herein, in which the more than one SRS resource is configured to be transmitted on same symbols, or on different continuous symbols, or on more than one different symbols which can span no longer than a configured/indicated number of symbols.
17. The method of any one or more of the solutions disclosed herein, in which the more than one SRS resource is configured to share one or more frequency domain parameters including at least one of a comb offset, a comb number, a frequency hopping parameter, or a partial frequency hopping parameter.
18. The method of any one or more of the solutions disclosed herein, in which ports of the transmission of the more than one SRS resource correspond to different cyclic shifts (CSs).
19. The method of any one or more of the solutions disclosed herein, in which the more than one SRS resource belongs to one SRS resource set, or belongs to different SRS resource sets.
20. The method of any one or more of the solutions disclosed herein, in which the more than one SRS resource is triggered at a same time, or triggered by a same DCI.
21. The method of any one or more of the solutions disclosed herein, in which the more than one SRS resource corresponds to different UE antenna ports; or in which the more than one SRS resource is configured with a same spatial filter, or associated with a same quasi-co-location type-D reference signal (RS).
22. The method of any one or more of the solutions disclosed herein, in which the PUSCH transmission is transmitted via 3 antenna ports.
23. The method of any one or more of the solutions disclosed herein, in which an SRS transmission is transmitted by the UE via the three antenna ports according to one SRS resource that is configured with the three antenna ports.
24. The method of any one or more of the solutions disclosed herein, in which an SRS transmission is transmitted by the UE via more than three ports according to one SRS resource that is configured with more than three ports.
25. The method of any one or more of the solutions disclosed herein, in which an SRS transmission is transmitted by the UE via three ports according to one SRS resource that is configured with more than three ports, and at least one of the more than three ports is excluded to determine three ports for the SRS transmission.
26. The method of any one or more of the solutions disclosed herein, in which the UE determines the three ports for the 3-port PUSCH transmission according to the three-port SRS transmission, or according to the more than three ports SRS transmission with at least one of the more than three ports being excluded to determine three ports for the PUSCH transmission.
27. The method of any one or more of the solutions disclosed herein, in which the more than one SRS resource is combined for the three-port PUSCH transmission when at least one of conditions is met including: that the UE is configured with three ports; that the UE supports three transmit antenna ports; that the UE is instructed to combine ports specified in the more than one SRI field; or that the sum of number of ports for the SRS resources indicated by the more than one SRI field is 3.
28. The method of any one or more of the solutions disclosed herein, further including: transmitting, by the UE to the BS, the PUSCH transmission according to antenna ports of one or more SRS resources indicated by the SRI information and a precoding information.
29. The method of any one or more of the solutions disclosed herein, in which the precoding information is indicated by a DCI signaling or by an RRC signaling, or in which the precoding information indicates one or more precoders, or in which the precoding information includes a transmit precoding matrix indicator (TPMI) for the PUSCH transmission, and/or an indication for a number of layers for the PUSCH transmission.
30. The method of any one or more of the solutions disclosed herein, in which a number of ports for the precoding information is determined according to a number of ports for the one SRS resource indicated for the PUSCH transmission, or according to a sum of numbers of ports for the more than one SRS resource indicated for the PUSCH transmission.
31. The method of any one or more of the solutions disclosed herein, in which: an SRS transmission related to the one or more SRS resources indicated by the SRI information is transmitted by the UE, or the PUSCH transmission is transmitted according to three antenna ports of one or more SRS resources indicated by the SRI information.
32. The method of any one or more of the solutions disclosed herein, in which: mapping between SRS ports and PUSCH ports is determined as: for more than one SRS resource associated with the PUSCH transmission, SRS ports with the following order are mapped to PUSCH ports in an ascending order: ports in one SRS resource in an ascending order, and then SRS resources in an ascending order; and the SRS resources order is determined by an SRS resource index, an SRS resource identification, an SRS resource indicator, or an SRS resources order indicated by the SRI information.
33. The method of any one or more of the solutions disclosed herein, in which: mapping between SRS ports and PUSCH ports is determined according to a mapping indication; the mapping indication indicating an order of more than one SRS resource for port mapping, or the mapping indication indicating a mapping relation between SRS ports and PUSCH ports among more than one predefined mapping relations.
34. The method of any one or more of the solutions disclosed herein, in which the mapping indication is indicated to the UE by the BS via an RRC signaling, a MAC CE, or a DCI signaling.
35. A wireless communication device including at least one processor configured to perform the method recited in any one or more of solutions 1-34.
36. One or more non-transitory computer-readable media storing computer-executable instructions that, when executed by one or more processors of a wireless communication device, cause the device to perform the method of any one of claims 1-34.

It will be appreciated that the present document discloses techniques that can be embodied in various embodiments to allow a UE-triggered reporting of beam report information. Specifically, events for beam reporting are defined based on measurement quality variation monitoring among beams at different time instances/beam groups or for different channels/RSs. The beam reporting would be triggered if any of the pre-defined events occurs. As the event-triggered beam report is initiated by the UE on demand, the reporting latency and uplink reporting resource consumption can be greatly reduced compared with the conventional beam report method.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method, comprising:
receiving, by a user equipment (UE) from a base station (BS), a sounding reference signal (SRS) configuration;
receiving, by the UE from the BS, SRS resource indicator (SRI) information for a physical uplink shared channel (PUSCH) transmission; and
transmitting, by the UE to the BS, the PUSCH transmission according to antenna ports of one or more SRS resources indicated by the SRI information;
wherein the SRI information indicates one SRS resource which is configured with 4 ports, and
in response to 3 transmit antenna ports being determined by the UE, an SRS transmission related to the one indicated SRS resource is transmitted by the UE using 3 ports, and
a transmit resource for the SRS transmission is determined based on a 4-port SRS pattern and a selection information.

2. A method, comprising:
transmitting, by a base station (BS) to a user equipment (UE), a sounding reference signal (SRS) configuration;
transmitting, by the BS to the UE, SRS resource indicator (SRI) information for a physical uplink shared channel (PUSCH) transmission; and
receiving, by the BS from the UE, the PUSCH transmission;
wherein the SRI information indicates one SRS resource which is configured with 4 ports, and
in response to 3 transmit antenna ports being determined by the UE, an SRS transmission related to the one indicated SRS resource is transmitted by the UE using 3 ports, and
a transmit resource for the SRS transmission is determined based on a 4-port SRS pattern and a selection information.

3. The method of claim 1, wherein the SRI information is indicated by a downlink control information (DCI) signaling or by a radio resource control (RRC) signaling.

4. The method of claim 1, wherein:
the SRI information indicates one SRS resource which is configured with 3 ports,
an SRS transmission related to the one indicated SRS resource is transmitted by the UE using 3 ports, and
a transmit resource for the SRS transmission is determined based on a 4-port SRS pattern and a selection information.

5. The method of claim 1, wherein the PUSCH transmission is transmitted using same three ports as the one SRS resource indicated by the SRI information.

6. The method of claim 1, wherein the transmit resource for the SRS transmission comprises at least one of a time domain resource, a frequency domain resource, a code domain resource, an orthogonal frequency-division multiplexing (OFDM) symbol index, a slot index, a comb offset, or a cyclic shift.

7. The method of claim 1, wherein:
the SRI information indicates one SRS resource which is configured with 4 ports; and
an SRS transmission related to the one indicated SRS resource is transmitted by the UE using 4 ports.

8. The method of claim 7, wherein the PUSCH transmission is transmitted using 3 ports among the 4 ports of the one SRS resource indicated by the SRI information based on a selection information, in response to 3 transmit antenna ports being determined by the UE.

9. The method of claim 1, wherein:
the selection information is predefined, or indicated by an RRC signaling; or
the selection information indicates that 1 port among the 4 ports of the 4-port SRS pattern is excluded from the PUSCH transmission or SRS transmission, or that 3 ports of the 4 ports of 4-port SRS pattern are involved in the PUSCH transmission or SRS transmission.

10. The method of claim 1, wherein:
the SRI information indicates one SRS resource which is configured with 3 ports; and at least one of:
an SRS transmission related to the one indicated SRS resource is transmitted by the UE using 3 ports; or
the PUSCH transmission is transmitted using same 3 ports as the one SRS resource indicated by the SRI information.

11. The method of claim 1, wherein the SRI information is indicated by one SRI field, or more than one SRI field.

12. The method of claim 1, wherein the PUSCH transmission is transmitted via 3 antenna ports.

13. The method of claim 12, wherein an SRS transmission is transmitted by the UE via three ports according to one SRS resource that is configured with more than three ports, and at least one of the more than three ports is excluded to determine three ports for the SRS transmission.

14. The method of claim 13, wherein the UE determines the three ports for the 3-port PUSCH transmission according to the more than three ports SRS transmission with at least one of the more than three ports being excluded to determine three ports for the PUSCH transmission.

15. The method of claim 1, further comprising:
transmitting, by the UE to the BS, the PUSCH transmission according to antenna ports of one or more SRS resources indicated by the SRI information and a precoding information.

16. The method of claim 15,
wherein the precoding information is indicated by a DCI signaling or by an RRC signaling, or
wherein the precoding information indicates one or more precoders, or
wherein the precoding information comprises at least one of: a transmit precoding matrix indicator (TPMI) for the PUSCH transmission, or an indication for a number of layers for the PUSCH transmission.

17. The method of claim 15, wherein a number of ports for the precoding information is determined
according to a number of ports for the one SRS resource indicated for the PUSCH transmission.

18. The method of claim 1, wherein the PUSCH transmission is transmitted according to three antenna ports of one or more SRS resources indicated by the SRI information.

19. A user equipment (UE), comprising:
at least one processor; and
at least one memory storing instructions that, when executed by the at least one processor, cause the UE at least to perform:
receiving, from a base station (BS), a sounding reference signal (SRS) configuration;
receiving, from the BS, SRS resource indicator (SRI) information for a physical uplink shared channel (PUSCH) transmission; and
transmitting, to the BS, the PUSCH transmission according to antenna ports of one or more SRS resources indicated by the SRI information;
wherein the SRI information indicates one SRS resource which is configured with 4 ports, and
in response to 3 transmit antenna ports being determined by the UE, an SRS transmission related to the one indicated SRS resource is transmitted by the UE using 3 ports, and
a transmit resource for the SRS transmission is determined based on a 4-port SRS pattern and a selection information.
